(19) United States
(12) Patent Application Publication
(10) Pub. No.: US 2006/0107462 A1
(43) Pub. Date: May 25, 2006

(54) Adjustable recliner or bed

(76) Inventor: Fried-Jan Unger, Arnheim (NL)

Correspondence Address: NILS H. LJUNGMAN;NILS H. LJUNGMAN & ASSOCIATES, P.O. BOX 130, GREENSBURG, PA, 15601-0130, US

(21) Appl. No.: 11/166,800

(22) Filed: Jun. 24, 2005

Related U.S. Application Data
(63) Continuation-in-part of application No. PCT/EP03/12285, filed on Nov. 4, 2003.
(63) Continuation-in-part of application No. PCT/EP03/12287, filed on Nov. 4, 2003.

(30) Foreign Application Priority Data
Dec. 27, 2002 (DE) 102 61 645.0
Dec. 27, 2002 (DE) 102 61 644.2

(51) Int. Cl. A61G 7/015

(52) U.S. Cl. 5/618; 5/424

(57) ABSTRACT

The application relates to reclining chairs or beds that are made of pivoting parts and have a motorized adjustment drive and prevent the user from injury caused by incorrect adjustments by limiting the pivoting movement of the parts of the recliners or beds, and by placing the small-volume adjusting device underneath the recliner or the bed, and by essentially ensuring that the distance between the motors remains unchanged during the adjustment of the recliner or the bed, so that the contour of the adjusting device, even after an adjustment, is essentially the same as the contour of the seating surface of the recliner or bed. The abstract of the disclosure is submitted herewith as required by 37 C.F.R. §1.72(b). As stated in 37 C.F.R. §1.72(b): “A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.” Therefore, any statements made relating to the abstract are not intended to limit the claims in any manner and should not be interpreted as limiting the claims in any manner.

### CONTINUING APPLICATION DATA

This application is a Continuation-In-Part application of International Patent Application No. PCT/EP2003/012285, filed on Nov. 4, 2003, which claims priority from Federal Republic of Germany Patent Application No. 102 61 645.0, filed on Dec. 27, 2002. This application is also a Continuation-In-Part application of International Patent Application No. PCT/EP2003/012287, filed on Nov. 4, 2003, which claims priority from Federal Republic of Germany Patent Application No. 102 61 644.2, filed on Dec. 27, 2002. International Patent Application Nos. PCT/EP2003/012285 and PCT/EP2003/012287 were both pending as of the filing date of this application. The United States was an elected state in both International Patent Application Nos. PCT/EP2003/012285 and PCT/EP2003/012287.

### BACKGROUND

1. Technical Field

This application relates to an adjustable recliner or bed. Only the term “recliner” is used below, although the concepts of a couch and a bed are also covered by the application.

2. Background Information

Recliners of this type have been known for an extremely long time. To adjust the recliners, the recliners are preferably divided into a plurality of segments that are connected to one another so that they can pivot. The parts are pivoted with respect to one another and/or with respect to the base frame.

The adjustment also includes at least one locking device to immobilize the movable parts in the current pivoted position.

The prior art also describes recliners that are simultaneously provided with a motorized adjustment in various parts. The motorized adjustment makes possible an adjustment while the occupant is sitting or lying on the recliner into any desired position. In the absence of a motorized adjustment, most people are forced to make several attempts to approximate the optimal position. During these adjustments they are required to stand up repeatedly, make an adjustment and then re-assume the seated or reclining position.

A motorized adjustment capability makes this repeated standing up and sitting down unnecessary. The comfort and convenience of a motorized adjustment are considered significant.

Recliners of the prior art have pivoting parts to adjust the position of the torso and of the legs. Some recliners are also provided with pivoting parts to adjust the position of the head and to adjust the position of the feet.

The prior art also describes the use of separate adjustment devices for each pivoting part or the use of adjusting motors as adjustment devices.

The independent adjustment devices allow the user to create an individual setting for the seat.

A recliner with a motorized adjustment is described in DE 19903112 A1, which provides an adjustment for the position of the torso and an adjustment for the position of the legs, each of which has a respective adjusting motor. However, the two motors move the pivoting parts of the recliner by means of an extensive lever mechanism. The corresponding levers are thereby located next to the recliner or underneath the recliner. DE 4305939 describes a chair with a motorized adjustment mechanism. Independent adjusting motors are designed to move the pivoting parts of the recliner. As on the recliner described above, however, the motors act on the pivoting parts by means of a lever mechanism, whereby the levers are located laterally in the recliner.

A recliner with a motorized adjustment is also described in U.S. Pat. No. 6,343,392. In this example of the prior art, like in DE 19903112 A1, provision is made to adjust the position of the torso and the position of the legs with respective adjusting motors. Provision is also made to adjust the position of the head and the position of the feet, although the adjustment for the position of the head and the adjustment for the position of the feet are derived by a movement mechanism from the pivot position of the pivoting parts that determine the position of the torso and the position of the legs.

A recliner with a motorized adjustment is also described in U.S. Pat. No. 4,258,445, which indicates several ways in which different reclining and seating settings can be achieved with a single mechanism. This document also shows several exemplary embodiments with pivoting parts as in U.S. Pat. No. 6,343,392. However, this prior art patent does not teach any further solutions that might be relevant here.

A recliner with a motorized adjustment is known from U.S. Pat. No. 4,407,030. This recliner of the prior art has a plurality of pivoting parts that are moved by adjusting motors. This publication explicitly refers to the risk of injury to the user. An extensive lever mechanism is provided between the motors and the pivoting parts of the recliner. The corresponding levers are located in the lateral portion of the recliner. The purpose of this arrangement is to increase stability, although it results in a significant risk of injury. In this case, the risk of injury is supposed to be prevented by sensors that react when a user inadvertently sticks hands or feed into the mechanism. However, the sensors present the problem that they react, within their reaction radius, to parts other than the user's hands and feet. Any covers or pieces of upholstery that hand down can cause the sensors to react. Likewise, any person or object that is too close to the recliner can also cause the sensors to react. It is therefore easy to understand why the sensor solution has not been adopted in actual practice. In addition, this prior art publication overlooks the fact that there is another risk of injury. The users are at risk of being bent double or of getting into another hazardous position on account of the various independent adjusting motors.

The motorized adjustment also presents a risk of injury to the user. This risk is present in particular when the seat consists of a seat part, with torso and leg parts fastened adjustably to it. When the parts are adjusted in relation to each other by a reclining person, the reclining person can become jammed between the two parts.

On other seats, there is a danger of injury to the feet, because the feet can become stuck under the foot portion.

### OBJECT OR OBJECTS

The object of at least one embodiment is therefore to essentially eliminate the risk of injury from hazardous pivoting positions. Another object of at least one possible embodiment is to essentially eliminate the risk of injury from a user getting his hands or feet caught in the adjusting mechanisms.

### SUMMARY

The application teaches that, in at least one embodiment, at least one separate adjusting motor is provided for each pivoting part that poses a danger of injury, and that for each adjusting motor, a displacement limiting device is provided to limit the displacement with respect to the neighboring part. The application teaches that, in at least one embodiment, the displacement limiting device is a computer which, when it reaches a hazardous pivoted position, blocks further movement. Therefore, in at least one embodiment, it is essentially ensured that neighboring parts of the recliner do not come excessively close to one another and thereby pose a risk of injury. The advantages are particularly important for seats with a torso part and a separate leg part.

The application also teaches that, in at least one embodiment, a displacement limiting device is preferably provided for the leg part and for the foot part, to prevent the feet from becoming jammed between the foot part and the base frame.

The control of the pivoting parts of a recliner is in itself of course described by DE4305939 A1. In that case, a control unit is provided with displacement transducers, such as analog transducers, for example. The signals from the analog transducers are transmitted via lines to the control unit. The control unit energizes the adjusting motors via lines with current pulses. In one exemplary embodiment, the control unit is provided with a process controller and memory. However, the control unit is used only to realize the desired movement and for the execution of a test movement of the pivoting parts upon completion of the manufacture of a recliner. No provision is made to prevent the hazardous pivoting movements described above.

The adjusting motors provided are preferably provided with an automatic interlock and/or with a stop. The automatic interlock can be created, for example, by using a transmission with a spindle or a threaded rod. A nut can thereby sit on the spindle or threaded rod, for example. The spindle or the threaded rod and/or the nut can be rotationally mounted. A gear wheel can also interact with the spindle. If a gear wheel is used, at least the spindle or the threaded rod is provided with a drive motor. The automatic interlocking action of the spindle or threaded rod is greater, the smaller the pitch of the spindle or the pitch of the thread on the threaded rod.

Instead of or in addition to the automatic interlocking device, a mechanical and/or electronic or electrical locking device can also be provided. Preferably a motorized locking device is provided.

Optionally, the spindle or the threaded rod and/or the nut are provided with a drive motor. The drive motors can simultaneously have a locking device. Stepper motors are advantageous. Stepper motors with locking devices in the current step position are commercially available.

In at least one other possible embodiment, the design of the recliner is based on the knowledge that the risk of injury is particularly great when a large and bulky adjustment mechanism is located under the recliner.

The application teaches that the adjusting device can have a small volume and be located under the recliner, and that even when there is a significant change in the position of the recliner, the adjusting device assumes approximately the contour of the seating surface of the recliner.

The application teaches the use of adjusting motors that are located at a short distance from each other in a line underneath the recliner, and the distance between which remains essentially unchanged when the pivoting parts are moved. A “short distance”, as used herein, refers to a distance of a maximum of 30 cm, preferably a maximum of 20 cm and even more preferably of a maximum of 15 cm.

The short distance between the motors is also ensured by the fact that the adjusting motors are arranged in a line one behind another and that the line follows at least approximately the contour of the recliner or bed as it is adjusted. The phrase “follows approximately”, as used herein, means that the longitudinal axis of an adjusting motor differs from the seating surface of the nearest pivoting part by a maximum of 20 degrees.

It is also advantageous to locate the adjusting devices under the center of the recliner or bed.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

One exemplary embodiment of the application is illustrated in the accompanying drawings.

FIG. 1 shows a perspective view of a recliner according to one possible embodiment;

FIG. 2 shows a side view of the recliner;

FIG. 2A shows the view shown in FIG. 2 with additional features according to possible embodiment;

FIG. 3 shows a side view of the recliner in a position different from that shown in FIG. 2;

FIG. 4 shows a side view of the recliner in a position different from that shown in FIGS. 2 and 3;

FIG. 5 shows a box drawing of the operative connections of the computer, sensors, user control, and motors according to one possible embodiment; and

FIG. 6 shows a representation of a bottom view of the recliner in a position as shown in FIG. 4 according to one possible embodiment.

### DESCRIPTION OF EMBODIMENT OR EMBODIMENTS

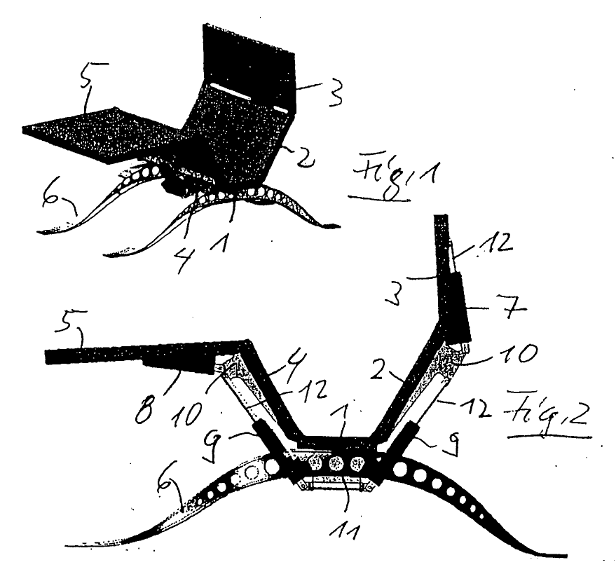

FIGS. 1 to 4 show a recliner with a seat part 1, a leg part 2, a foot part 5, a torso part 2 and a head part 2. The different parts are connected to one another in an articulated manner. In the exemplary embodiment, the articulations are conventional hinges with moving parts that are engaged with one another and are connected to one another by hinge bolts. In other exemplary embodiments, flexible parts made of plastic or spring steel sheet can be used as hinges.

The seat part 1 is simultaneously rigidly connected with a fixed base frame. The fixed base frame has rounded feet 6 made of aluminum profiles. To reduce the weight, a perforated profile is used. In the exemplary embodiment, two profiles located at some distance from each other are provided with a curved shape. The curve has its maximum curvature in the area in which it comes into contact with the seat part 1. Toward the ends of the recliner, the curvatures decreases, until the profiles come into contact with the base frame. The profiles are also tapered toward the ends.

Parts 10 and 11 are also provided on the parts 1, 2 and 3. These parts form reinforcement and bearing brackets for the articulated attachment of electric elevating motors 9. On the foot part 5 and the head part 3, bearing brackets are also provided, although they are not shown in the exemplary embodiment.

The elevating motors have a spindle 12 which is extended out of the housing by rotation and can be retracted again.

The spindles 12 are connected in an articulated manner on the head with the facing part 10 which forms a bearing bracket. On the other end of the elevating motors 8 and 9, an articulated connection with the parts 10 and 11 is provided.

All the elevating motors are electrical stepper motors that can be locked in the current step position.

The elevating motors are provided with a pivoting limitation. In the illustrated exemplary embodiment, the pivoting is limited by means of a computer, whereby the step position is measured and the pivoted position is determined from the current step position. This measurement can be made empirically or on the basis of the geometry of the parts that participate in the pivoting movement. For the empirical determination, the pivot position that corresponds to each step position is measured. By a comparison of the data that correspond to each pivot position, it is possible to prevent the further extension of a elevating motor or the further retraction of a elevating motor and an excessive closeness of the moving parts or an excessive distance between the moving parts. In the exemplary embodiment, the computer acts on the control system that controls the elevating motors, so that the elevating motors can be moved only in the safe direction, i.e. retracted or extended in a direction that reduces any potential hazard.

In the exemplary embodiment, the elevating motors are designed so that in every position of the parts 1 to 5, an adjustment is possible in response to a spot load at the farther end of the parts. Therefore even extremely overweight people can sit or lie on any desired point of the recliner and still make a motorized adjustment of the recliner.

In an additional exemplary embodiment, the chair is designed to support a load of 200 kg, and in additional exemplary embodiments, the recliner is designed to support a load of only 100 kg.

Regardless of the question of the adjustment force, the parts 1 to 5 and the adjustment mechanism are designed so that they will withstand the load applied. This concept also includes the design of the base frame, with regard to both strength and stability.

The elevating motors 8 and 9 are located at a short distance from the parts 1 to 5, so that the elevating motors, when viewed from the side of the recliner, lie essentially in a line one behind the other, whereby the line in FIG. 4 runs approximately parallel to the contour of the seating surface of the recliner, and in the recliner positions illustrated in FIGS. 1 to 3, the line follows the contour of the recliner seating surface, i.e. it has essentially the same contour.

The term “essentially the same” includes variations of the longitudinal axis of the elevating motor up to 20 degrees from the position parallel to the closest part of the reclining chair or to the seating surface of the closest part of the reclining chair.

In the exemplary embodiment, the distance between the elevating motors 8 and 9 is 15 cm, while in other exemplary embodiments it can be up to 20 cm or 30 cm.

The construction described above provides advantageous clearance between the adjustment mechanism and the floor and reduces the risk of injury. Therefore, in at least one embodiment, the user's feet can essentially be prevented from becoming jammed in the adjustment mechanism.

In the illustrated exemplary embodiment, the adjustment mechanism is also located centrally underneath the recliner, so that the adjustment mechanism is out of reach of the user's hands, and thereby prevents injuries to the user's hands.

In the illustrated exemplary embodiment, a mattress-shaped cushion (not shown) sits on the parts 1 to 5, and the cushion and the mechanism of the recliner (Parts 1 to 5 and their adjustment) are covered by cushion upholstery (not shown). This feature also contributes to the safety of the recliner.

In other exemplary embodiments, the cushion encloses the parts 1 to 5 and their adjustment mechanisms.

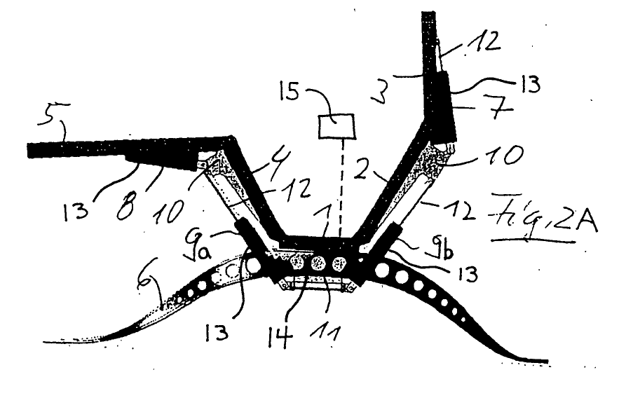

When an adjustment is made, in the exemplary embodiment any further pivoting movement of the parts 2 and 4 is blocked when the parts enclose a pivot angle of less than 70 degrees between them. The position is illustrated in FIGS. 1 and 2. In other exemplary embodiments, the limit angle selected is a smaller or larger enclosed angle. The limit can be changed by changing the computer data.

In FIGS. 1 and 2, the foot part 5 is horizontal.

The computer and the control system, in the manner described above, also prevent the foot part 5 from coming into contact with the floor or ground. In other exemplary embodiments, a certain clearance is provided between the end of the foot part 5 and the floor or ground, so that if a foot or feet are inadvertently placed underneath the foot part 5, they are not injured.

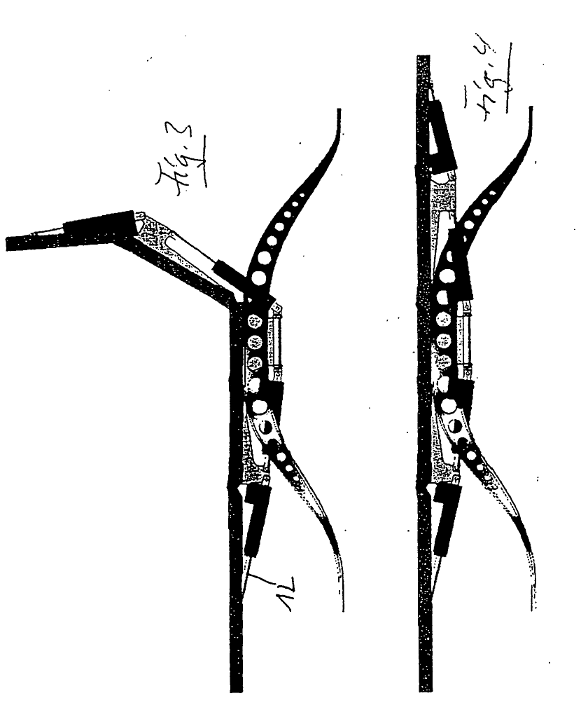

FIG. 3 shows a recliner position in which both parts 4 and 5 are horizontal.

FIG. 4 shows a recliner position in which all the parts 1 to 5 are horizontal.

FIG. 2A shows the view shown in FIG. 2 with additional features according to one possible embodiment. Specifically, sensors 13, a control computer 14, and a user control or interface 15 are shown. The sensors 13 are located, in this particular embodiment, in each of the elevating motors 7, 8, 9a, 9b. The sensors 13 detect the position of the spindles 12 and send the information to the control computer 14. The control computer 14 processes the information to determine the position of inclination or movement of each section of the recliner. A user can program or control the recliner by utilizing a user control or interface 15. The user control can be any suitable control device, such as a keypad or touchpad. As discussed above, the computer 14, upon detection of a hazardous or unsafe position of the parts of the recliner, can halt the movement or operation of the motors 7, 8, 9a, 9b and their corresponding spindles 12 in order to protect the user from injury.

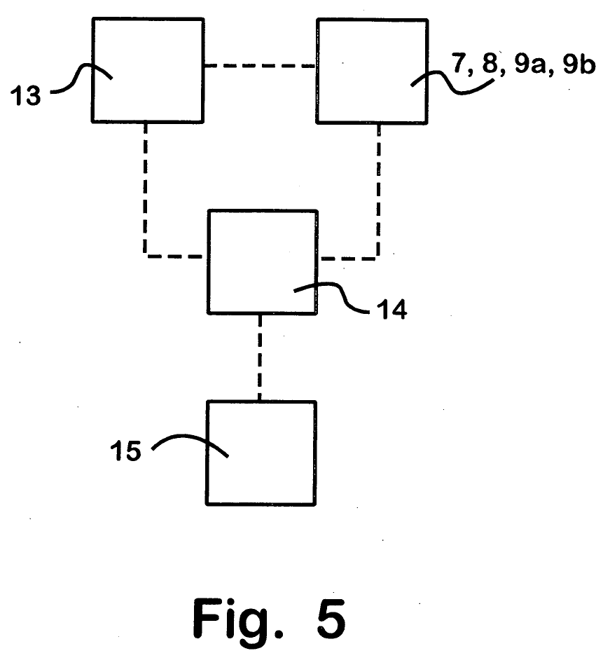

FIG. 5 shows a box drawing of the operative connections of the computer 14, sensors 13, user control 15, and motors 7, 8, 9a, 9b according to one possible embodiment. As can be seen in FIG. 5, the user inputs data into the computer 14 via the user control 15. The computer 14 uses the user data in conjunction with the data from the sensors 13 to control and/or restrict the operation of the motors 7, 8, 9a, 9b to protect the user from injury.

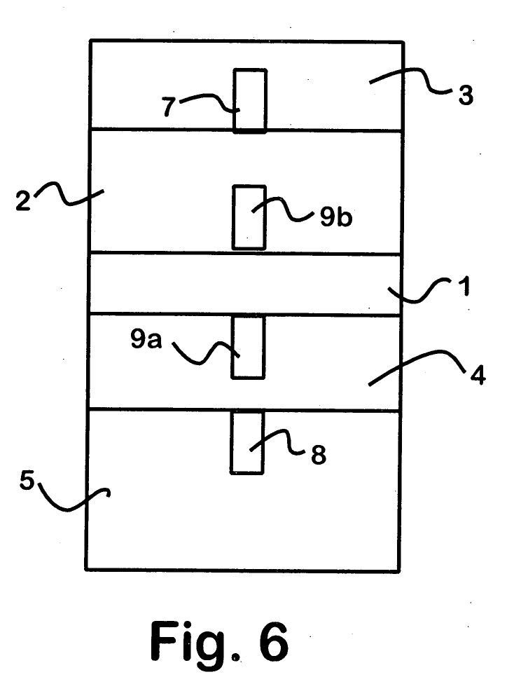

FIG. 6 shows a representation of a bottom view of the recliner in a position as shown in FIG. 4 according to one possible embodiment. FIG. 6 shows that the motors 7, 8, 9a, 9b are aligned and centrally located on the underside of their corresponding parts 1, 2, 3, 4, 5.

In at least one possible embodiment, the recliner could be programmed for use by a user with an existing injury or condition, such as an injured neck, back, or leg. Such an injured user may not be able to utilize all of the positions of the chair that would be usable by a healthy person. The injured user could program the computer to prevent movement of portions of the recliner beyond a particular position or inclination to protect the injured user from further injuring the injured portion of the user's body.

In at least one other possible embodiment, the sensors could be used to detect a surge or fluctuation in electrical charge in the motors, which would indicate that the motor is being overworked by resistance to movement of the corresponding portion of the recliner. The computer, upon receiving such data, could stop the operation of the motor in question, thereby possibly preventing the motor from continuing operation that would damage the motor or operation that would injure the user. For example, if a user were to somehow insert his hand or foot into the small spaces between the motors and the chair sections, the computer could detect the increased resistance and therefore increased strain on the motor to stop the motor from running to minimize or prevent injury to the user. This type of automatic shutoff system would be especially useful in protecting children or pets from being accidentally caught in the recliner, even though the design of the recliner is such that the opportunity for accidental injury is reduced in comparison to recliners of the prior art.

One feature or aspect of an embodiment is believed at the time of the filing of this patent application to possibly reside broadly in an adjustable recliner or bed with pivoting parts and separate adjusting devices, in particular with adjusting motors, primarily with a pivoting part to adjust the position of the torso and with a pivoting part to adjust the position of the legs, and preferably with a pivoting part to adjust the position of the head or a pivoting part to adjust the position of the feet, whereby the parts can be adjusted in relation to one another and/or in relation to the floor or ground, characterized in that the adjustment movement is limited by a determination of the adjustment displacement in a computer which, when a hazardous pivot position is reached, blocks any further movement.

Another feature or aspect of an embodiment is believed at the time of the filing of this patent application to possibly reside broadly in a recliner or bed, wherein the pivot position is determined from pivot angles that have been determined empirically with a step-wise adjustment of the adjusting device, whereby the corresponding pivoting angle is determined on the basis of the adjustment displacement, or that the pivoting position is calculated from the geometry of the adjustment device and from the adjustment displacement.

Yet another feature or aspect of an embodiment is believed at the time of the filing of this patent application to possibly reside broadly in a recliner or bed, wherein adjusting motors are used that are provided with rotationally mounted and driven spindles or threaded rods, so that the spindles or threaded rods can be extended or retracted.

Still another feature or aspect of an embodiment is believed at the time of the filing of this patent application to possibly reside broadly in a recliner or bed comprising spindles or threaded rods with an automatic locking action.

A further feature or aspect of an embodiment is believed at the time of the filing of this patent application to possibly reside broadly in a recliner or bed, wherein stepper motors are used as adjusting devices.

Another feature or aspect of an embodiment is believed at the time of the filing of this patent application to possibly reside broadly in a recliner or bed comprising pivoting parts that can support a spot load on their outer end of at least 100 kg, preferably of at least 200 kg and particularly preferably of at least 300 kg.

Yet another feature or aspect of an embodiment is believed at the time of the filing of this patent application to possibly reside broadly in a recliner or bed comprising a base frame that is stable at loads of at least 100 kg, preferably at lease 200 kg and particularly preferably at loads of at least 300 kg on the foot part and/or the head part of the recliner.

Still another feature or aspect of an embodiment is believed at the time of the filing of this patent application to possibly reside broadly in a recliner or bed comprising a base frame made of aluminum profile that is made of aluminum profiles, in particular perforated profiles.

A further feature or aspect of an embodiment is believed at the time of the filing of this patent application to possibly reside broadly in a recliner or bed, wherein reinforcing parts and/or bearing brackets are used for the adjusting devices on the pivoting parts.

Another feature or aspect of an embodiment is believed at the time of the filing of this patent application to possibly reside broadly in a recliner or bed comprising a pivoting connection of the adjusting devices with the bearing brackets or the pivoting parts.

One feature or aspect of an embodiment is believed at the time of the filing of this patent application to possibly reside broadly in an adjustable recliner or bed with more than two pivoting parts and whereby one pivoting part adjusts the position of the torso and has an adjusting device, whereby another pivoting part adjusts the position of the legs, and has a separate adjusting device, whereby there is also a part to adjust the position of the head and/or a part to adjust the position of the feet, characterized by the fact that the part to adjust the position of the head and the part to adjust the position of the feet are each provided with a separate adjustment device, whereby the part to adjust the position of the feet is connected in an articulated manner to the part to adjust the position of the legs, and whereby the part to adjust the position of the head is connected in an articulated manner to the part to adjust the position of the torso, and that the adjusting device has a small volume and is located under the recliner or the bed and that the distance to the seating surface of the recliner or bed remains essentially unchanged during the movement of the pivoting parts.

Another feature or aspect of an embodiment is believed at the time of the filing of this patent application to possibly reside broadly in a recliner or bed comprising various adjusting motors that are arranged in a line one behind the other underneath the recliner, and in that the line at least approximately follows the contour of the recliner or bed as it is adjusted.

Yet another feature or aspect of an embodiment is believed at the time of the filing of this patent application to possibly reside broadly in a recliner or bed, wherein an average distance of the adjusting motors from the recliner seating surface of up to 30 cm, preferably up to 20 and particularly preferably up to 15 cm.

Still another feature or aspect of an embodiment is believed at the time of the filing of this patent application to possibly reside broadly in a recliner or bed, wherein the longitudinal axis of an adjusting motor varies from the seating surface of the nearest pivoting part by a maximum of 20 degrees.

A further feature or aspect of an embodiment is believed at the time of the filing of this patent application to possibly reside broadly in a recliner or bed, wherein the adjusting device is located centrally under the recliner.

Another feature or aspect of an embodiment is believed at the time of the filing of this patent application to possibly reside broadly in a recliner or bed, wherein adjusting motors are used that can be extended and retracted by means of rotationally mounted and driven spindles and threaded rods.

Yet another feature or aspect of an embodiment is believed at the time of the filing of this patent application to possibly reside broadly in a recliner or bed, wherein an upholstery covering and/or a cushion are provided the enclose the adjusting device.

Still another feature or aspect of an embodiment is believed at the time of the filing of this patent application to possibly reside broadly in a recliner or bed comprising a base frame made of aluminum profile that is made of aluminum profiles, in particular perforated profiles.

A further feature or aspect of an embodiment is believed at the time of the filing of this patent application to possibly reside broadly in a recliner or bed, wherein the aluminum profile is curved, whereby the profile is connected in the vicinity of its maximum curvature with a seat part, and the ends of the aluminum profile emerge toward the ground.

Another feature or aspect of an embodiment is believed at the time of the filing of this patent application to possibly reside broadly in a recliner or bed, wherein the profile is tapered toward the ends, and wherein two profiles enclose the adjusting device between them.

The components disclosed in the various publications, disclosed or incorporated by reference herein, may possibly be used in possible embodiments of the present invention, as well as equivalents thereof.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

The appended drawings in their entirety, including all dimensions, proportions and/or shapes in at least one embodiment of the invention, are accurate and are hereby included by reference into this specification.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

All, or substantially all, of the components and methods of the various embodiments may be used with at least one embodiment or all of the embodiments, if more than one embodiment is described herein.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

All of the patents, patent applications and publications recited herein, and in the Declaration attached hereto, are hereby incorporated by reference as if set forth in their entirety herein.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

It will be understood that the examples of patents, published patent applications, and other documents which are included in this application and which are referred to in paragraphs which state “Some examples of . . . which may possibly be used in at least one possible embodiment of the present application . . . ” may possibly not be used or useable in any one or more embodiments of the application.

The sentence immediately above relates to patents, published patent applications and other documents either incorporated by reference or not incorporated by reference.

All of the patents, patent applications or patent publications, which were cited in the International Search Report dated Feb. 16, 2004, and the International Preliminary Examination Report dated Nov. 23, 2004, and/or cited elsewhere are hereby incorporated by reference as if set forth in their entirety herein as follows: U.S. Pat. No. 4,407,030; U.S. Pat. No. 6,343,392; U.S. Pat. No. 4,258,445; DE 199 03 112; and DE 43 05 939.

The corresponding foreign and international patent publication applications, namely, Federal Republic of Germany Patent Application No. 102 61 645.0, filed on Dec. 27, 2002, having inventor Fried-Jan UNGER, and DE-OS 102 61 645.0 and DE-PS 102 61 645.0, and International Application No. PCT/EP2003/012285, filed on Nov. 4, 2003, having WIPO Publication No. WO2004/058010 and inventor Fried-Jan UNGER, Federal Republic of Germany Patent Application No. 102 61 644.2, filed on Dec. 27, 2002, having inventor Fried-Jan UNGER, and DE-OS 102 61 644.2 and DE-PS 102 61 644.2, and International Application No. PCT/EP2003/012287, filed on Nov. 4, 2003, having WIPO Publication No. WO2004/058011 and inventor Fried-Jan UNGER, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

Some examples of load sensors and components thereof which may possibly be used or adapted for use in at least one possible embodiment may possibly be found in the following U.S. Pat. No.: 6,612,194, entitled “Shifter with load sensors for sensing shift demands;” U.S. Pat. No. 6,002,090, entitled “Force sensitive scale for fork lifts with electronically coupled load sensors;” U.S. Pat. No. 4,503,715, entitled “Load sensors;” U.S. Pat. No. 6,647,795, entitled “Capacitive physical load sensor and detection system;” U.S. Pat. No. 6,634,235, entitled “Load sensor with strain-sensing elements;” U.S. Pat. No. 6,609,432, entitled “Load sensor, pinch detection apparatus and load detection apparatus;” U.S. Pat. No. 6,606,914, entitled “Load sensor, load sensor unit and insertion detection device;” U.S. Pat. No. 6,556,024, entitled “Capacitance type load sensor;” U.S. Pat. No. 6,532,830, entitled “High payload six-axis load sensor;” U.S. Pat. No. 6,484,593, entitled “Load sensor with flexing and strainable beam members;” U.S. Pat. No. 6,371,733, entitled “Pump with hydraulic load sensor and controller;” U.S. Pat. No. 6,293,160, entitled “Load sensor and pointing equipment incorporating the same;” U.S. Pat. No. 6,252,311, entitled “Load sensor and controller/manager;” 6,216,547, entitled “Load sensor;” U.S. Pat. No. 6,211,793, entitled “Safety belt load sensor;” U.S. Pat. No. 6,134,947, entitled “Load sensor for measuring engine cylinder pressure and seat occupant weight;” U.S. Pat. No. 6,104,100, entitled “Charge transfer load sensor;” U.S. Pat. No. 6,065,353, entitled “Piezoelectric load sensor, and process for detecting load-applied position;” and U.S. Pat. No. 6,062,106, entitled “Side load sensor.”

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

Some examples of linear position sensors and components thereof which may possibly be used or adapted for use in at least one possible embodiment may possibly be found in the following U.S. Pat. No.: 6,577,123, entitled “Linear position sensor assembly;” U.S. Pat. No. 6,556,946, entitled “Linear position sensor;” U.S. Pat. No. 6,483,295, entitled “Inductive linear position sensor including exciting and receiving coils and a movable induction coupling element;” U.S. Pat. No. 6,448,759, entitled “Non-contact linear position sensor for motion control applications with inductive attenuating coupler;” U.S. Pat. No. 6,411,081, entitled “Linear position sensor using magnetic fields;” U.S. Pat. No. 6,369,689, entitled “Linear position sensor using a strain gage;” U.S. Pat. No. 6,316,936, entitled “Linear position sensor for a transmission manual valve;” U.S. Pat. No. 6,304,078, entitled “Linear position sensor;” U.S. Pat. No. 6,215,299, entitled “Linear position sensor having a permanent magnet that is shaped and magnetized to have a flux field providing a sensor output that varies linearly between opposite end points of relative linear movement between the magnet and sensor;” U.S. Pat. No. 6,190,319, entitled “Self calibrating linear position sensor;” U.S. Pat. No. 6,075,371, entitled “Linear position sensor;” U.S. Pat. No. 6,057,682, entitled “Dual rotational and linear position sensor;” U.S. Pat. No. 5,811,967, entitled “EGR valve linear position sensor having variable coupling transformer;” U.S. Pat. No. 5,642,043, entitled “Linear position sensor;” U.S. Pat. No. 5,565,770, entitled “Linear position sensor including a first open housing having a reciprocal, biased magnet holder and magnet and removable second housing having a hall sensor;” U.S. Pat. No. 5,519,326, entitled “Linear position sensor using a coaxial resonant cavity;” U.S. Pat. No. 5,491,422, entitled “Linear position sensor using a coaxial resonant cavity;” U.S. Pat. No. 5,438,274, entitled “Linear position sensor using a coaxial resonant cavity;” U.S. Pat. No. 5,325,063, entitled “Linear position sensor with means to eliminate spurians harmonic detections;” U.S. Pat. No. 5,241,278, entitled “Radio frequency linear position sensor using two subsequent harmonics;” U.S. Pat. No. 5,210,490, entitled “Linear position sensor having coaxial or parallel primary and secondary windings;” U.S. Pat. No. 5,182,979, entitled “Linear position sensor with equalizing means;” U.S. Pat. No. 5,150,060, entitled “Multiplexed radio frequency linear position sensor system;” U.S. Pat. No. 5,074,053, entitled “Magnetically actuated linear position sensor;” U.S. Pat. No. 5,045,785, entitled “Linear position sensor with movable tapered element;” U.S. Pat. No. 4,909,560, entitled “Digital linear position sensor;” U.S. Pat. No. 4,737,705, entitled “Linear position sensor using a coaxial resonant cavity;” U.S. Pat. No. 4,121,185, entitled “Linear position sensor;” and U.S. Pat. No. 4,088,977, entitled “Contactless linear position sensor.”

The details in the patents, patent applications and publications may be considered to be incorporable, at applicant's option, into the claims during prosecution as further limitations in the claims to patentably distinguish any amended claims from any applied prior art.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.
   Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

What is claimed is:

1. An adjustable recliner or bed with pivoting parts and separate adjusting devices, in particular with adjusting motors, primarily with a pivoting part to adjust the position of the torso and with a pivoting part to adjust the position of the legs, and preferably with a pivoting part to adjust the position of the head or a pivoting part to adjust the position of the feet, wherein the parts can be adjusted in relation to one another and/or in relation to the floor or ground, wherein the adjustment movement is limited by a determination of the adjustment displacement in a computer which, when a hazardous pivot position is reached, blocks any further movement.

2. Recliner or bed as claimed in claim 1, wherein the pivot position is determined from pivot angles that have been determined empirically with a step-wise adjustment of the adjusting device, wherein the corresponding pivoting angle is determined on the basis of the adjustment displacement, or that the pivoting position is calculated from the geometry of the adjustment device and from the adjustment displacement.

3. Recliner or bed as claimed in claim 2, wherein adjusting motors are used that are provided with rotationally mounted and driven spindles or threaded rods, so that the spindles or threaded rods can be extended or retracted.

4. Recliner or bed as claimed in claim 3, comprising spindles or threaded rods with an automatic locking action.

5. Recliner or bed as claimed in claim 4, comprising the use of stepper motors as adjusting devices.

6. Recliner or bed as claimed in claim 5, comprising pivoting parts that can support a spot load on their outer end of at least 100 kg, preferably of at least 200 kg and particularly preferably of at least 300 kg.

7. Recliner or bed as claimed in claim 6, comprising the use of a base frame that is stable at loads of at least 100 kg, preferably at lease 200 kg and particularly preferably at loads of at least 300 kg on the foot part and/or the head part of the recliner.

8. Recliner or bed as claimed in claim 7, comprising a base frame made of aluminum profile that is made of aluminum profiles, in particular perforated profiles.

9. Recliner or bed as claimed in claim 8, comprising the use of reinforcing parts and/or bearing brackets for the adjusting devices on the pivoting parts.

10. Recliner or bed as claimed in claim 9, comprising a pivoting connection of the adjusting devices with the bearing brackets or the pivoting parts.

11. An adjustable recliner or bed with more than two pivoting parts and comprising one pivoting part adjusts the position of the torso and has an adjusting device, wherein another pivoting part adjusts the position of the legs, and has a separate adjusting device, wherein there is also a part to adjust the position of the head and/or a part to adjust the position of the feet, wherein the part to adjust the position of the head and the part to adjust the position of the feet are each provided with a separate adjustment device, wherein the part to adjust the position of the feet is connected in an articulated manner to the part to adjust the position of the legs, and wherein the part to adjust the position of the head is connected in an articulated manner to the part to adjust the position of the torso, and that the adjusting device has a small volume and is located under the recliner or the bed and that the distance to the seating surface of the recliner or bed remains essentially unchanged during the movement of the pivoting parts.

12. Recliner or bed as claimed in claim 11, comprising various adjusting motors that are arranged in a line one behind the other underneath the recliner, and in that the line at least approximately follows the contour of the recliner or bed as it is adjusted.

13. Recliner or bed as claimed in claim 12, comprising an average distance of the adjusting motors from the recliner seating surface of up to 30 cm, preferably up to 20 and particularly preferably up to 15 cm.

14. Recliner or bed as claimed in claim 13, wherein the longitudinal axis of an adjusting motor varies from the seating surface of the nearest pivoting part by a maximum of 20 degrees.

15. Recliner or bed as claimed in claim 14, wherein the adjusting device is located centrally under the recliner.

16. Recliner or bed as claimed in claim 15, wherein adjusting motors are used that can be extended and retracted by means of rotationally mounted and driven spindles and threaded rods.

17. Recliner or bed as claimed in claim 16, wherein an upholstery covering and/or a cushion are provided the enclose the adjusting device.

18. Recliner or bed as claimed in claim 11, comprising a base frame made of aluminum profile that is made of aluminum profiles, in particular perforated profiles.

19. Recliner or bed as claimed in claim 18, wherein the aluminum profile is curved, wherein the profile is connected in the vicinity of its maximum curvature with a seat part, and the ends of the aluminum profile emerge toward the ground.

20. Recliner or bed as claimed in claim 19, wherein the profile is tapered toward the ends, and wherein two profiles enclose the adjusting device between them, and wherein the parts can be adjusted in relation to one another and/or in relation to the floor or ground, wherein the adjustment movement is limited by a determination of the adjustment displacement in a computer which, when a hazardous pivot position is reached, blocks any further movement.
